(19) United States
(12) Patent Application Publication
(10) Pub. No.: US 2016/0183725 A1
(43) Pub. Date: Jun. 30, 2016

(54) BARBECUE GRILL WITH COOLER AND TRANSPORT CASE

(71) Applicant: Brandon Cragg, Lauderdale by the Sea, FL (US)

(72) Inventor: Brandon Cragg, Lauderdale by the Sea, FL (US)

(21) Appl. No.: 14/941,159

(22) Filed: Nov. 13, 2015

Related U.S. Application Data
(60) Provisional application No. 62/079,038, filed on Nov. 13, 2014.

(51) Int. Cl. A47J 37/07

(52) U.S. Cl. CPC A47J 37/0763; A47J 2037/0777

(57) ABSTRACT

A barbecue and cooler assembly includes a collapsible barbecue grill, a thermally insulated case and a cooler supported on a main transport structure. The case is sized and configured for storing the collapsed barbecue grill. The case with the collapsed grill therein fits within the cooler for compact storage and transport. When the grill is removed from the case and assembled for use, the case serves as a food warmer. The main transport structure includes wheels and an extendable handle for easy transportation of the entire assembly. The main transport structure further includes an entertainment system including a TV monitor, speakers and a rechargeable battery power source.

### BACKGROUND OF THE INVENTION

1. Field of the Invention

The present invention relates to grilling devices and, more particularly, to a grilling device for use in combination with a cooler and transport device.

2. Discussion of the Related Art

Tailgating has become a common social activity wherein individuals gather before or after sporting events, concerts and other forms of entertainment. Tailgating attendees typically consume beverages, grill various meat products and other foods, and play games. The act of transporting a grill and related equipment to and from tailgating parties can be cumbersome and there exists a need for an easily transportable grilling device including accessories, such as a cooler and/or food warmer, as well as one or more electronic devices, such as a television and/or audio speakers.

The present invention serves to provide a barbecue grill that is adapted for easy storage and transportation. The present invention further serves to provide a thermally insulated cooler and/or food warmer in combination with the barbecue grill.

### SUMMARY OF THE INVENTION

The present invention is directed to a barbecue and cooler assembly including a collapsible barbecue grill, a thermally insulated case, and a main transport structure with a cooler, a TV display, speakers and battery power source. The case has a foil-lined inner facing surface and is sized and configured for storing the collapsed (i.e., disassembled) barbecue grill when the barbecue grill is not in use. When the grill is removed from the case, the case serves as a food warmer, wherein the foil-lined inner facing surface of the walls of the case serve to keep food therein warm. The case, containing the collapsed grill therein, can be stowed inside of the cooler for transport of the entire assembly. The main transport structure includes wheels for easy transportation of the barbecue grilling device. The walls of the cooler are thermally insulated for decreasing the rate of heat exchange through the walls, thereby allowing ice, beverages and food to be stored therein.

### OBJECTS AND ADVANTAGES OF THE INVENTION

Considering the foregoing, it is a primary object of the present invention to provide a cooler and barbecue grilling assembly that is easily transportable.

It is a further object of the present invention to provide a cooler and barbecue grilling assembly including a barbecue grill, cooler and food warmer.

It is a further object of the present invention to provide a cooler and barbecue grilling assembly including a TV and speakers on the cooler.

These and other objects and advantages of the present invention are readily apparent with reference to the detailed description and accompanying drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a front perspective view of the cooler and barbecue assembly of the present invention shown in a fully collapsed state and packaged for transport;

FIG. 2 is a rear elevational view of the cooler and barbecue grill assembly of FIG. 1;

FIG. 3 is an exploded perspective view showing a grill/food warmer case being removed from a cooler compartment of the main transport structure;

FIG. 4 is a front, top perspective view showing the grill/food warmer case open with a collapsed barbecue grill stowed therein;

FIG. 5 is a perspective view showing the fully assembled barbecue grill once removed from the case;

FIG. 6 is an isolated perspective view of a rear panel of the main transport structure showing a cap removed from a drain port of the cooler;

FIG. 7 is a front perspective view showing an entertainment panel on the front of the main transport structure;

FIG. 8 is an isolated side perspective view showing a battery storage compartment in the base of the main transport structure with a door to the battery compartment open to reveal a rechargeable battery source and outlet connections for various electrical connections that plug into the rechargeable battery source; and

FIG. 9 is a top perspective view showing a protective cover of the entertainment panel removed and assembled as a table.

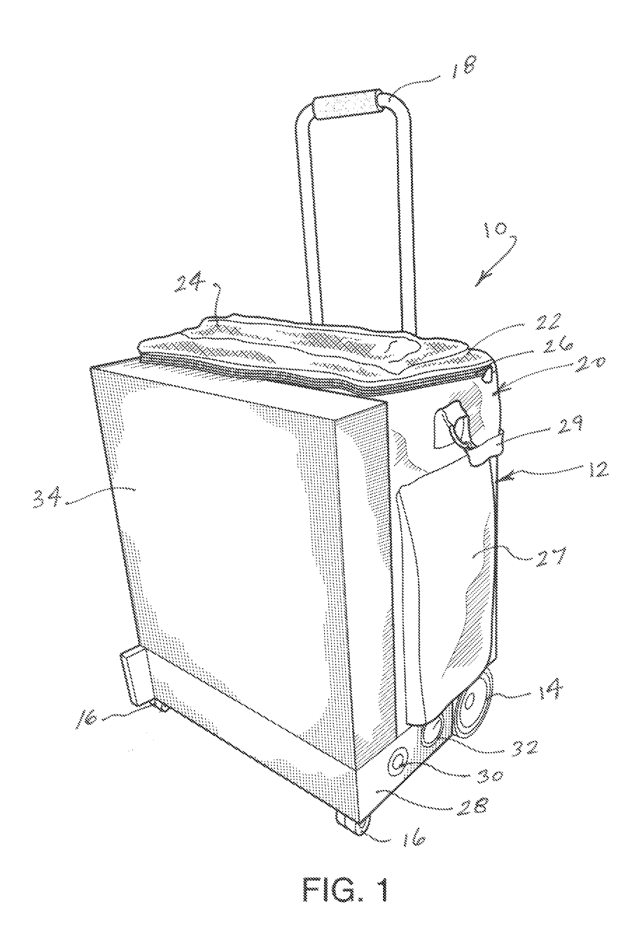

### DETAILED DESCRIPTION OF THE PREFERRED EMBODIMENT

Referring to the several views of the drawings, the present invention is directed to a combined barbecue and cooler assembly, generally indicated as 10. The assembly 10 is specifically structured for ease of transport. More particularly, the assembly 10 includes a main transport structure 12 that is supported on wheels, including rear wheels 14 and front wheels 16 which, along with an extendable handle 18 allow for ease of transport of the entire assembly 10. The extendable handle 18 is similar to that found on a typical wheeled suitcase.

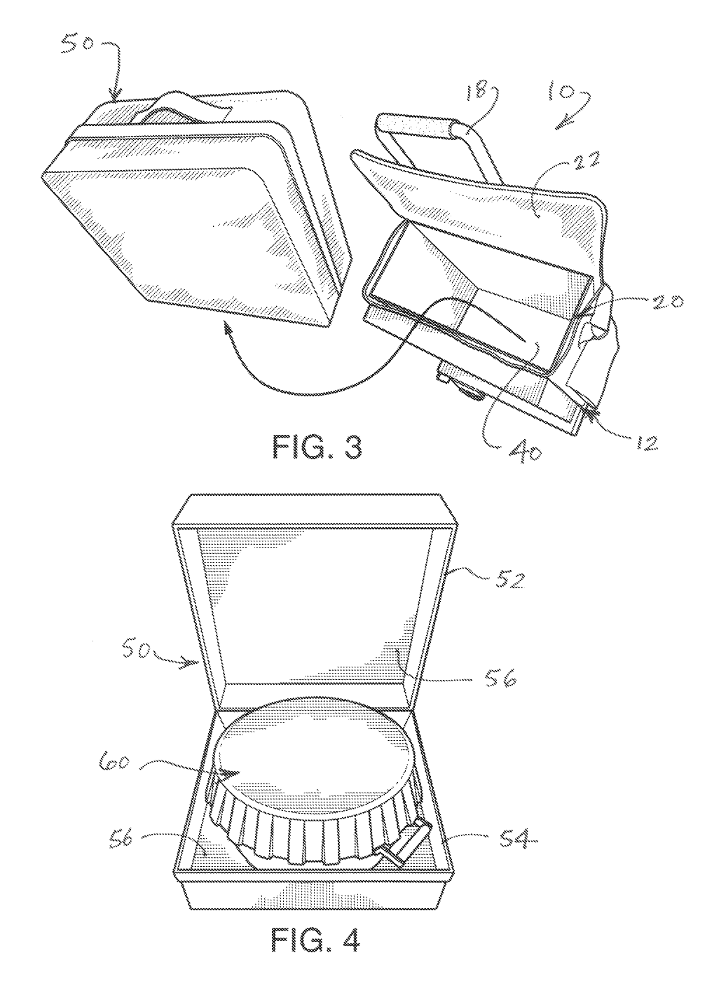

The main transport structure 12 further includes a cooler 20 that is insulated and structured for holding ice, as well as beverages and food items therein. The cooler 20 includes a top lid 22 that swings open to allow access to an interior cooler compartment 40 (see FIG. 3). In a preferred embodiment, the cooler 20 includes a rigid interior shell structure that is thermally insulated (i.e., foam filled). The rigid shell is received within a soft exterior case which may include the top lid 22. The top lid 22 is secured closed with a zipper 26. A storage compartment 24, such as a mesh bag with a zipper opening, is provided on the top of the lid 22 for holding items, such as legs 35 of a table assembly (see FIG. 9). A lower portion of the main transport structure 12 includes a battery storage compartment 28 which essentially forms a false bottom to the cooler. This lower compartment 28 also functions as a chassis for supporting the weight of the assembly 10 as well as the attachment of the wheels 14 and 16. A power outlet, such as an AC converter (i.e., similar to a cigarette lighter in an automobile) is provided on the side of the battery storage compartment (see 30). The side of the battery storage compartment 28 may further be provided with a charge indicator gauge 32 for indicating the amount of electric charge remaining on the battery storage source contained within the compartment 28. Front protective cover 34 removes from the front of the main transport structure 12 to reveal an entertainment panel 70. The protective cover 34 serves to protect the electronic components on the entertainment panel 70 and, when removed, functions as a table, as seen in FIG. 9. Specifically, the legs 35 can be removed from the pouch 24 on the top of the cooler and attached to the bottom side of the protective cover 34 to form the table, as seen in FIG. 9.

Referring to FIGS. 3-5, a case 50 is sized and configured for removable receipt within the interior cooler compartment 40 for transport. The case 50 functions as both a barbecue grill storage and transport case, as well as a food warmer. Specifically, a case 50 is structured for holding a collapsed barbecue grill 60 therein. Once removed from the cooler compartment 40, the case 50 can be opened to reveal an interior compartment that is sized, structured and configured for holding a collapsed barbecue grill 60, as seen in FIG. 4. A top portion 52 and bottom portion 54 of the case 50 are both lined with an interior insulative foil lining that is removable if desired. The foil lining serves to insulate the top and bottom portions 52, 54 of the case 50 so that once the barbecue grill is removed, the case can function as a food warmer.

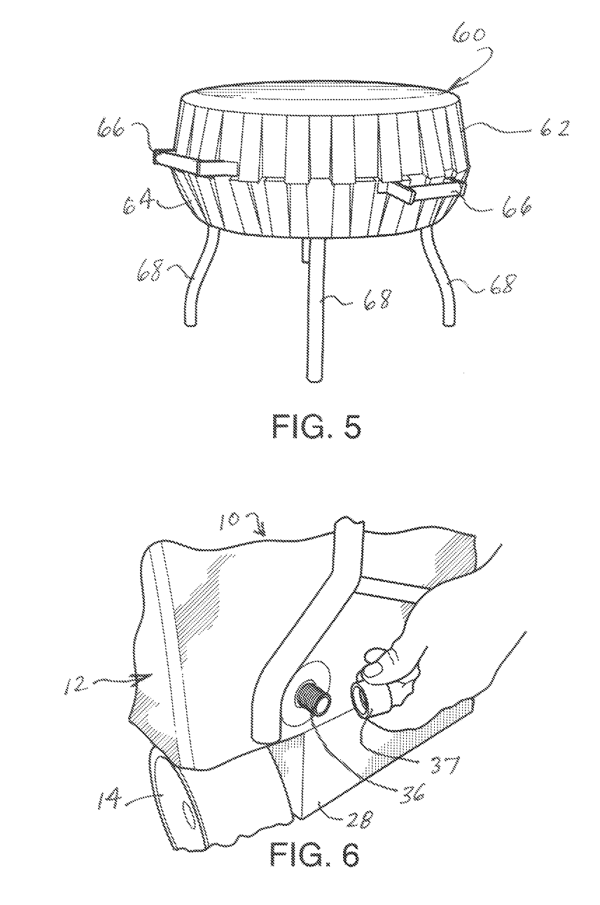

The barbecue grill 60 is removed from the case 50 and assembled for use, as seen in FIG. 5. In a preferred embodiment, the barbecue grill 60 includes a top half 62 and a bottom half 64 that are each shaped to resemble bottle caps. The top 62 of the barbecue grill 60 is hinged to the bottom 64 so that the top 62 can be opened for grilling. The barbecue grill will naturally include a grill surface inside and may also be equipped with vents on the bottom and/or top, as well as means for connecting a portable propane tank, including a gas burner and regulator (not shown). The barbecue grill 60 further includes removable handles 66 and removable legs 68. When removed from the barbecue grill, the legs 68 can be stowed in a side pouch 27 on an exterior side of the main transport structure 12. The main transport structure 12 may further include a shoulder strap 29 for purposes of carrying the main transport structure 12 in situations where the assembly cannot be wheeled over a surface.

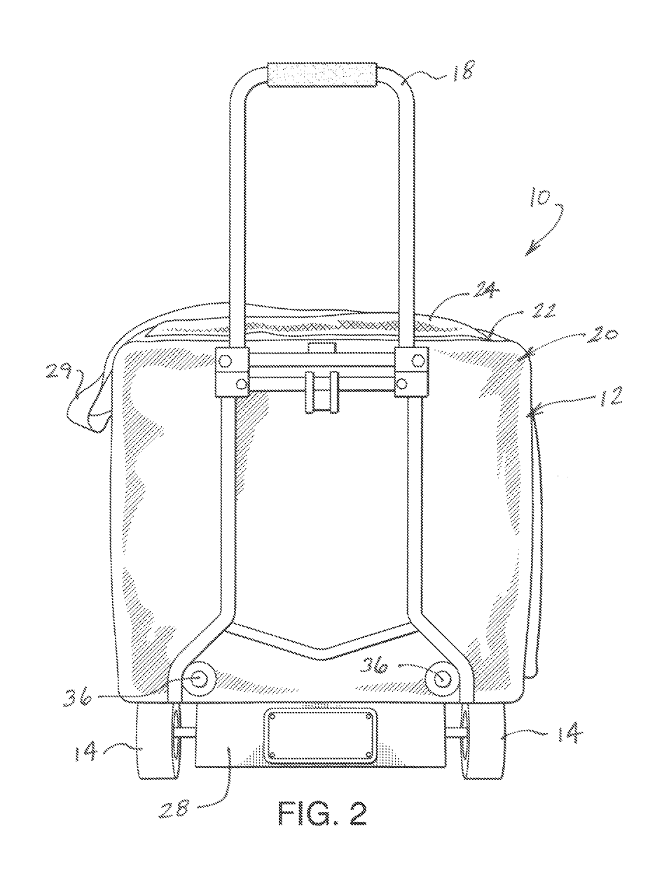

Referring to FIG. 6, a drain port 36 on the back panel of the main transport structure 12 communicates with the interior cooler compartment 40 to allow the cooler compartment 40 to be drained of liquid (i.e., melted ice). Specifically, a cap 37 screws onto the port 36 to close the port, and can be unscrewed and removed to allow drainage out through the port 36. As seen in FIG. 2, two drainage ports 36 may be provided for efficient draining of the cooler compartment 40.

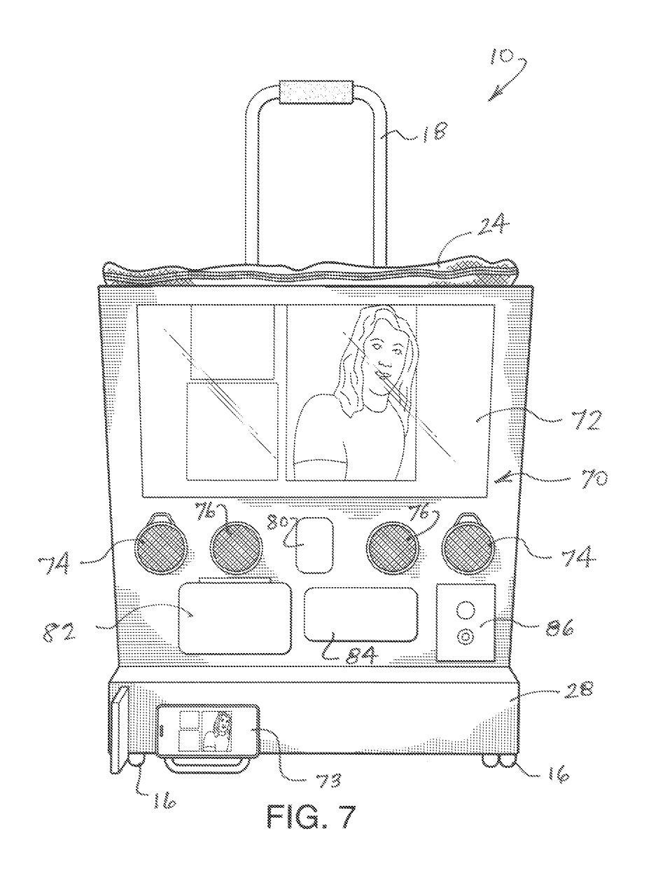

Referring to FIG. 7, the entertainment panel 70 on the front of the main transport structure 12 includes a TV monitor 72, such as an LCD display. A wireless communication mirroring device 80 may be provided on the front panel 70 for wireless communication with a portable electronic device, such as a cell phone 73. This allows for video and photos viewed on the portable electronic device 73 to be simultaneously displayed on the TV monitor 72. The entertainment panel 70 further includes a plurality of speakers including removable speakers 74 and fixed speakers 76. Music from an external device, such as the portable electronic device 73, as well as other forms of audio can be played from the speakers. For examples, digital music stored on a portable electronic device 73 can be played with the sound emitted from the speakers 74 and 76. The speakers 74, 76 in combination with the portable electronic device 73 may also be used to provide a karaoke machine. The entertainment panel 70 may further include a storage compartment 82 that is essentially similar to a glove box for storing items such as a wallet, cell phone, and other small items. A removable, portable battery charging device 84 is also provided on the entertainment panel 70 and can be removed therefrom for providing a source of portable battery power and a quick charge or jumper charge for other electronic equipment and batteries. An outlet 86 on the entertainment panel 70 may provide various connection ports for electronic devices, as well as a battery recharge connection.

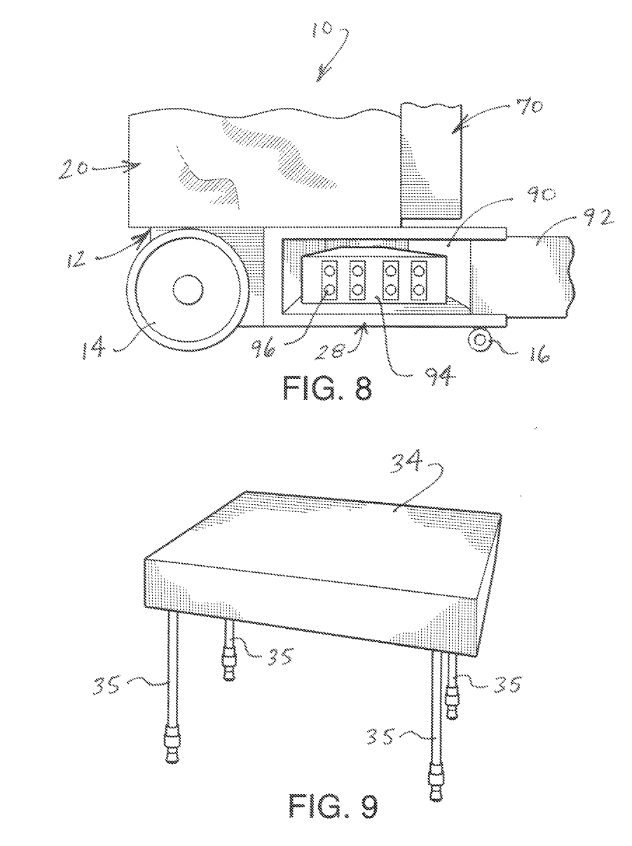

Referring to FIG. 8, the battery storage compartment 28 includes an interior compartment 90 for storing one or more portable and rechargeable battery power sources 94. A door 92 normally covers and closes the compartment interior 90 and can be moved to an open position, as seen in FIG. 8 to reveal the portable battery source including a plurality of outlets for plugging in various electronic devices.

While the present invention has been shown and described in accordance with several preferred and practical embodiments thereof, it is recognized that departures from the instant disclosure are fully contemplated within the spirit and scope of the invention.

What is claimed is:

1. A barbecue and cooler assembly comprising:
a collapsible barbecue grill including a main grill body having a top half and a bottom half and a plurality of removable legs;
a storage case for containing the collapsed barbecue grill therein including at least the main grill body, and the case including a thermally insulated interior for maintaining warm or hot food items therein when the barbecue grill is removed; and
a main transport structure supported on a plurality of wheels and including an extendable handle 18 allowing the main transport structure to be rolled over a ground surface, and the main transport structure including an insulated cooler sized and configured for containing the case therein with the case containing the collapsed barbecue grill, and the main transport structure further including an entertainment panel including a TV monitor and a plurality of speakers, and a battery storage compartment for containing at least one battery power source therein.
